(19) United States
(12) Patent Application Publication
(10) Pub. No.: US 2025/0165796 A1
(43) Pub. Date: May 22, 2025

(54) SYSTEMS AND METHODS FOR EXECUTING CONFIDENCE-AWARE REINFORCEMENT LEARNING

(71) Applicants: Guiliang LIU, Shenzhen (CN); Pascal POUPART, Kitchener (CA); HUAWEI TECHNOLOGIES CANADA CO., LTD., Kanata (CA)

(72) Inventors: Pascal POUPART, Kitchener (CA); Guiliang LIU, Shenzhen (CN); Mohammed ELMAHGIUBI, Richmond Hill (CA)

(21) Appl. No.: 18/516,125

(22) Filed: Nov. 21, 2023

(51) Int. Cl. G06N 3/092

(52) U.S. Cl. CPC G06N 3/092

(57) ABSTRACT

Methods and systems for executing confidence-aware reinforcement learning for an Artificial Intelligence (AI) model for subsequent deployment of that AI model in an environment are disclosed. The method includes accessing a set of expert trajectories, each expert trajectory comprising a sequence of expert state-action pairs, the expert entities complying with an expert constraint that is unknown. The method also includes generating a main constraint for the set of expert trajectories, the main constraint being conditioned on a pre-determined confidence level, the pre-determined confidence level being indicative of a probability that the main constraint is at least as constraining as the expert constraint, the main constraint comprising one or more rules limiting the actions that are executable by the AI model, determining a target policy among a plurality of policies, the target policy complying with the main constraint and executing the target policy by the AI model.

### FIELD

The present technology relates generally to neural networks; and in particular, to systems and methods for executing confidence-aware reinforcement learning.

### BACKGROUND

In a reinforcement learning system, an agent interacts with an environment by receiving an observation that either fully or partially characterizes the current state of the environment, and in response, performing an action selected from a predetermined set of actions. The reinforcement learning system receives rewards from the environment in response to the agent performing actions and selects the action to be performed by the agent in response to receiving a given observation in accordance with an output of a value function representation. The value function representation takes as an input an observation and an action and outputs a numerical value that is an estimate of the expected rewards resulting from the agent performing the action in response to the observation.

Some reinforcement learning systems use a neural network to represent the value function. That is, the system uses a neural network that is configured to receive an observation and an action and to process the observation and the action to generate a value function estimate.

Some other reinforcement learning systems use a tabular representation of the value function. That is, the system maintains a table or other data structure that maps combinations of observations and actions to value function estimates for the observation-action combinations.

Constraints are inferred from expert entities and used for optimization of policies in current reinforcement learning pipelines. Said expert entities comply with one or more expert constraints that are unknown to the reinforcement learning systems. However, in current technologies, the constraints inferred from the expert entities are typically not associated with confidence levels indicative of whether or not they comply with unknown expert constraint entities that were respected by the expert entities.

A system that may perform reinforcement learning while providing a confidence level indicative that an inferred constraint is at least as constraining as the unknown expert constraint is thus desirable.

### SUMMARY

Developers have devised methods and devices for overcoming at least some drawbacks present in prior art solutions.

In one aspect, the present technology provides techniques for learning confidence-aware constraints from expert demonstrations in inverse constraint reinforcement learning (ICRL). For example, in the context of autonomous driving, human drivers often follow unspecified constraints to ensure safety and comfort. Since it may be cumbersome and time-consuming to manually specify suitable constraints for safety and comfort, it is common practice to learn such constraints from human demonstrations. Hence given a set of human demonstrations, such techniques infer constraints that those expert demonstrations satisfy most of the time. In practice, it may be desirable to obtain constraints for a desired level of confidence. However, existing techniques do not allow practitioners to specify the desired level of confidence that should be achieved by the inferred constraints. They simply return constraints. As we will see in subsequent sections, (approximate) Bayesian techniques return distributions over constraints, but they do not provide a way to identify the least constraining constraint that achieves at least a desired level of confidence. This invention describes the first approach that takes as input a confidence level with a set of expert demonstrations and outputs a constraint that is at least as constraining as the true constraint with the desired level of confidence. This ensures that any policy that satisfies the outputted constraint will necessarily satisfy the true underlying constraint with the desired confidence level. In addition, prior art does not indicate whether the number of expert trajectories is sufficient to learn a constraint with the desired level of confidence. This invention describes a first approach that answers this question and provides an approach to increase the number of expert trajectories until a suitable high level confidence constraint is inferred with a corresponding satisfying policy that achieves at least a desired threshold value.

Some of the know techniques usually alternate between two steps: 1) constrained policy optimization and 2) constraint adjustment. In constrained policy optimization, constraints or distribution over constraints are taken as input and an optimal policy that maximizes rewards subject to the constraints or some expectation with respect to the distribution of constraints is outputted. In constraint adjustment, the set of constraints or the distribution of constraints are updated to disallow trajectories induced by the optimal policy that do not resemble the expert trajectories. Therefore, it can be said that those existing techniques infer constraints, but do not offer any notion of confidence that the inferred constraints are at least as constraining as the true underlying constraint.

In a first broad aspect of the present technology, there is provided a computer-implemented method for executing confidence-aware reinforcement learning for an Artificial Intelligence (AI) model for subsequent deployment of that AI model in an environment. The method includes accessing a set of expert trajectories. Each expert trajectory includes a sequence of expert state-action pairs, a given one of the expert trajectories including information about a given state of the environment and a corresponding action that is to be executed in response to the given state, the expert entities complying with an expert constraint that is unknown. The method also includes generating a main constraint for the set of expert trajectories, the main constraint being conditioned on a pre-determined confidence level, the pre-determined confidence level being indicative of a probability that the main constraint is at least as constraining as the expert constraint, the main constraint comprising one or more rules limiting the actions that are executable by the AI model. The method also includes determining a target policy among a plurality of policies, the target policy complying with the main constraint and executing the target policy by the AI model.

In some non-limiting implementations, the method further includes accessing a set of policies, each policy being a mapping from states to actions for the sequences of expert state-action pairs of the expert trajectories, an execution of the policy aiming at maximizing a reward, determining a policy complying with the main constraint and executing the policy by iteratively executing the actions of the policy, receiving indication of rewards from and states of the environment, and adjusting the policy based on outcomes of the actions and received rewards.

In some non-limiting implementations, the method further includes, prior to executing the policy, determining a policy-value of the target policy, and in response to the policy-value being below a pre-determined value threshold, flagging the set of expert trajectories as insufficient.

In some non-limiting implementations, the method further includes augmenting the set of expert trajectories with additional expert trajectories until the policy-value exceeds the pre-determined value threshold.

In some non-limiting implementations, determining the policy-value of the policy includes determining an expected cumulative reward based on rewards associated with the action-state pairs of the policy.

In some non-limiting implementations, generating a main constraint for the set of expert trajectories includes determining a constraint distribution based on the set of expert trajectories, and selecting a constraint from the constraint distribution based on the pre-determined confidence level as the main constraint.

In some non-limiting implementations, the constraint distribution is a beta distribution.

In some non-limiting implementations, selecting the constraint from the constraint distribution includes selecting the lower boundary constraint of a quantile of the constraint distribution based on the pre-determined confidence level.

In some non-limiting implementations, the main constraint is:

quantile_{P(c)}(1−λ)

where P(c) is the constraint distribution and λ is the pre-determined confidence level.

In some non-limiting implementations, determining a constraint distribution includes employing a neural network encoding the set of expert trajectories to determine, for each of the expert trajectory, a set of contribution factors and adjusting a template distribution according to the set of contribution factors to form the constraint distribution.

In some non-limiting implementations, each expert trajectory is encoded with a corresponding encoder having corresponding weights in the neural network.

In a second broad aspect of the present technology, there is provided a system for executing confidence-aware reinforcement learning for an Artificial Intelligence (AI) model for subsequent deployment of that AI model in an environment. The system includes a controller and a memory storing a plurality of executable instructions which, when executed by the controller, cause the system to access a set of expert trajectories. Each expert trajectory includes a sequence of expert state-action pairs, a given one of the expert trajectories including information about a given state of the environment and a corresponding action that is to be executed in response to the given state, the expert entities complying with an expert constraint that is unknown. The system also generates a main constraint for the set of expert trajectories, the main constraint being conditioned on a pre-determined confidence level, the pre-determined confidence level being indicative of a probability that the main constraint is at least as constraining as the expert constraint, the main constraint comprising one or more rules limiting the actions that are executable by the AI model. The system also determines a target policy among a plurality of policies, the target policy complying with the main constraint and execute the target policy by the AI model.

In some non-limiting implementations, the system is further configured to access a set of policies, each policy being a mapping from states to actions for the sequences of expert state-action pairs of the expert trajectories, an execution of the policy aiming at maximizing a reward, determine a policy complying with the main constraint, and execute the policy by iteratively executing the actions of the policy, receiving indication of rewards from and states of the environment, and adjusting the policy based on outcomes of the actions and received rewards.

In some non-limiting implementations, the system is further configured to, prior to executing the policy, determine a policy-value of the target policy, and in response to the policy-value being below a pre-determined value threshold, flag the set of expert trajectories as insufficient.

In some non-limiting implementations, the system further augments the set of expert trajectories with additional expert trajectories until the policy-value exceeds the pre-determined value threshold.

In some non-limiting implementations, the system further determines, upon determining the policy-value of the policy, an expected cumulative reward based on rewards associated with the action-state pairs of the policy.

In some non-limiting implementations, the system is further configured to, upon generating a main constraint for the set of expert trajectories, determine a constraint distribution based on the set of expert trajectories, and select a constraint from the constraint distribution based on the pre-determined confidence level as the main constraint.

In some non-limiting implementations, the constraint distribution is a beta distribution.

In some non-limiting implementations, the system is further configured to select the constraint from the constraint distribution by selecting the lower boundary constraint of a quantile of the constraint distribution based on the pre-determined confidence level.

In some non-limiting implementations, the main constraint is:

quantile_{P(c)}(1−λ)

where P(c) is the constraint distribution and λ is the pre-determined confidence level.

In some non-limiting implementations, the system is further configured to, upon determining a constraint distribution, employ a neural network encoding the set of expert trajectories to determine, for each of the expert trajectory, a set of contribution factors and adjust a template distribution according to the set of contribution factors to form the constraint distribution.

In some non-limiting implementations, each expert trajectory is encoded with a corresponding encoder having corresponding weights in the neural network.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a block diagram of a computing environment for performing reinforcement learning in accordance with some implementations of the present technology;

FIG. 2 is a schematic representation of a pipeline for adjusting a number of expert trajectories used to optimize a policy subjected to an inferred constraint by a reinforcement learning system in accordance with some implementations of the present technology;

FIG. 3 is a schematic representation of a pipeline for inferring a constraint that is at least as constraining as an unknown expert constraint with a probability at least as great as a desired confidence level in accordance with some implementations of the present technology;

FIG. 4 is a schematic representation of an architecture of encoders of a neural network employed by a reinforcement learning system to optimize a policy based on expert trajectories according to a pre-determined confidence level in accordance with some implementations of the present technology;

FIG. 5 is a flow diagram of steps of a method for executing confidence-aware reinforcement learning for an Artificial Intelligence (AI) model for subsequent deployment of that AI model in an environment in accordance with some implementations of the present technology; and

FIG. 6 is a block diagram of a controller in accordance with some implementations of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the reinforcement learning, a state (noted s) is a representation of a situation of the environment. A current state is thus a representation of the current situation of the environment. The agent may decide which action should be taken based on the state of the environment. It should be noted that the state can be partial or complete.

In the same context, actions (noted a) of the agent are the set of possible moves or decisions the agent can make to influence the environment. The agent selects actions to achieve a current goal.

In the same context, a policy (noted π) is a strategy or mapping from states to actions, defining how the agent decides what action to take for a given state of the environment. In other words, a policy is a strategy or a mapping that defines how an agent should behave in a given environment. It specifies the agent's decision-making process by determining which actions the agent should take in response to different states or situations. The goal of a policy is to maximize a cumulative reward the agent receives over time (i.e. over the execution of the actions the policy). In this context, a reward (noted R) is a numerical signal provided by the environment to evaluate the agent's actions. The agent's objective is to maximize the cumulative reward over time. A value function (noted V-function) is a function that estimates the expected cumulative reward that an agent can achieve starting from a particular state and following a specific policy. It helps the agent evaluate the desirability of different states of the environment. A Q-value function (noted Q-function) is similar to the value function but also takes into account the action taken in addition to the state of the environment. It estimates the expected cumulative reward for taking a specific action in a given state and following a policy.

A policy can be deterministic or stochastic. In a deterministic policy, for each possible state, there is a specific action that the agent should take. The policy thus directly maps states to actions. For example, if a robot is following a deterministic policy, it might have a rule that says “if the robot detects an obstacle in front of it, turn left.” In a stochastic policy, the selection of actions to be executed is determined by probabilities. The policy specifies the probability distribution over possible actions for each state. It can be said that a stochastic policy might allow for some randomness and exploration in the agent's behavior.

A policy thus guides the agent's decision-making process. Reinforcement learning algorithms aim to learn the most performing policy (e.g. maximized reward) for a given task. This can involve exploring different policies and evaluating their performance in terms of the cumulative rewards received. Once an optimal policy is found, the agent can use it to make decisions in the environment. For example, in a self-driving car application, the policy could determine when to accelerate, brake, or turn the steering wheel based on the current traffic conditions and the car's position. The policy is learned over time through interactions with the environment, and it adapts to changing conditions to ensure safe and efficient driving.

In summary, a policy in reinforcement learning is a strategy that specifies the agent's actions in response to states in the environment, and it plays a central role in helping the agent maximize the cumulative reward.

In the context of reinforcement learning, an expert trajectory, also known as an expert demonstration or expert data, refers to a sequence of state-action pairs that are provided by an “expert” entity (human or not) to demonstrate how a specific task or problem should be solved. These demonstrations are used to train or guide a reinforcement learning agent by providing examples of appropriate behavior or solutions to the problem.

Expert trajectories typically consist of the following components: a sequence of state-action pairs, a state s including a description of the environment's current situation or configuration, an action a taken by the expert entity when the environment is in state s to demonstrate the appropriate or desirable behavior.

Using expert trajectories may help in leveraging human expertise to initialize or guide the learning process of a reinforcement learning agent. By observing and learning from these expert demonstrations, the agent can better understand how to achieve the task or maximize the cumulative reward. Expert trajectories can be particularly useful in situations where defining a reward function or specifying an appropriate policy is challenging. By learning from expert-provided examples (e.g. human-provided examples), the agent can accelerate its learning process and, in some cases, achieve better performance more quickly. For example, in a game-playing scenario, an expert trajectory might consist of a recorded sequence of moves made by a skilled human player. The reinforcement learning agent can then learn from this trajectory to improve its own performance in the game.

Expert trajectories are often used in imitation learning, where the agent aims to mimic the behavior demonstrated by the expert. There are various algorithms and approaches, such as behavioral cloning and generative adversarial imitation learning (GAIL), that use expert trajectories to teach reinforcement learning agents to perform tasks effectively.

It should be noted that policies and expert trajectories serve different purposes in the context of reinforcement learning. A policy is a strategy used by a reinforcement learning agent to make decisions in an environment. It specifies how the agent selects actions based on states to maximize cumulative rewards. In reinforcement learning, the goal is often to learn an optimal policy through interactions with the environment and the use of reward signals. Policies guide the agent's decision-making process during learning and execution. In contrast, an expert trajectory, or expert demonstration, is a sequence of state-action pairs provided by a human or an expert to show how a specific task should be performed. Expert trajectories are typically not learned by the agent as they are provided by expert-entities as examples of how a task should be accomplished. Expert trajectories are used as training data to guide the learning process of the agent. The agent can learn from the demonstrated behavior in the trajectory and attempt to imitate it.

In the context of reinforcement learning, constraints are introduced to ensure that the agent's behavior adheres to certain rules or limits during the learning process. These constraints can be important in specific applications or scenarios where safety or specific behavior requirements are critical.

Different types of constraints may be defined. For example, safety constraints may be important in real-world applications to prevent the agent from taking actions that may lead to undesirable or dangerous situations. For example, in autonomous driving, constraints can be used to ensure that the vehicle doesn't violate traffic rules or cause accidents. As another example, task-specific constraints may also be defined with respect to natural constraints that should be followed. For instance, in a robotic assembly line, constraints can be applied to ensure that the robot assembles products correctly, following a pre-defined process. As yet another example, exploration constraints may be defined in exploration-heavy scenarios to limit the exploration space of the agent. This is done to focus learning on the most relevant states and actions. Constraints can help prevent the agent from taking excessive or risky exploration actions. As yet another example, soft constraints may be defined and used to guide the learning process without strictly enforcing them. These constraints can be used as penalties in the reward function to discourage the agent from taking certain actions or entering specific states, rather than outright prohibiting them.

Constraints are typically incorporated into the reinforcement learning framework through modifications to the reward function or by altering the optimization process. For example, constraints can be added to the reward function as penalties, or specialized constraint optimization methods can be used in combination with traditional reinforcement learning algorithms to ensure that the agent's policy complies with the desired constraints.

In reinforcement learning, the balance between achieving high rewards and adhering to constraints can be a challenging problem, particularly in applications where safety is paramount.

With these fundamentals in place, we will now consider some non-limiting examples to illustrate various implementations of aspects of the present technology.

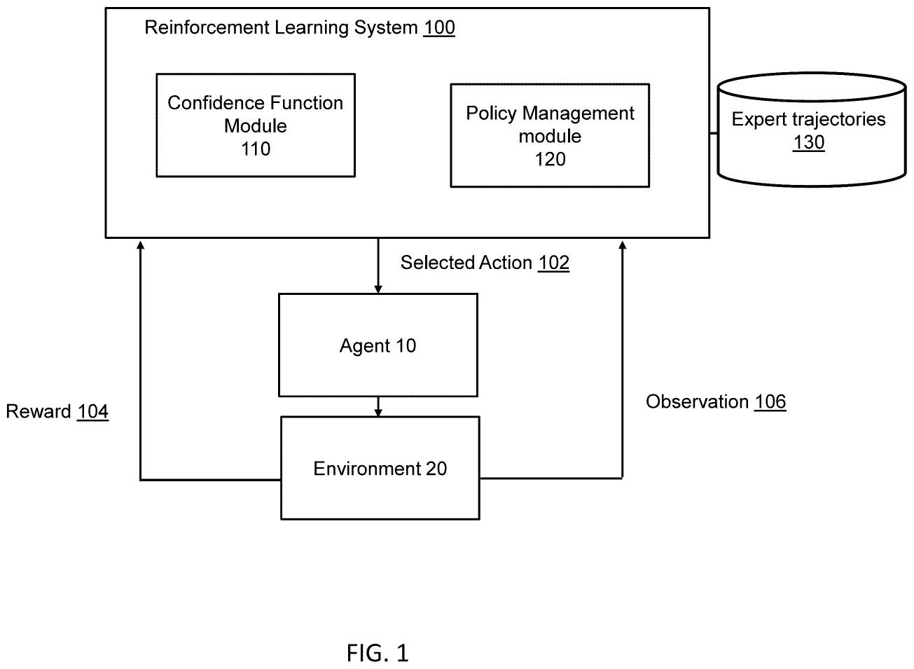

FIG. 1 shows an example reinforcement learning system 100. The reinforcement learning system 100 is an example of a system implemented as one or more computer programs on one or more computers in one or more locations in which the systems, components, and techniques described below are implemented. The reinforcement learning system 100 selects actions to be performed by an agent 10 that interacts with an environment 20. In particular, the reinforcement learning system 100 receives an observation 106 characterizing a current state of the environment 20 and uses a policy management module 120 to select an action 102 to be performed by the agent 10 while the environment is in the current state. In some implementations, the environment 20 may be a real-world environment. In some of these implementations, the reinforcement learning system 100 may be implemented as one or more computer programs on one or more computers embedded in a mechanical agent interacting with the environment 20. For example, the mechanical agent may be a semi- or fully-autonomous vehicle, watercraft, or aircraft or an underwater, on land, in the air, in space, or industrial robot. In some other implementations, the environment 20 may be a virtualized environment. The agent 10 may thus be a computer program that interacts with the virtualized environment 20. In some of these implementations, the reinforcement learning system 100 may be implemented as one or more computer programs on the same computer or computers as the agent.

As will be seen, teachings of the present disclosure may be applicable a variety of application fields such as, without limitation, autonomous driving, robotics and computer networks.

In use, the policy management module 120 uses a value function representation that estimates the return resulting from the agent performing specific actions when the environment 20 is in a given state. In some implementations, the value function representation is a machine learning model, e.g., a deep neural network, that is configured to receive as input a state representation for an environment state and an action from the set of actions and to output a value function estimate for the state-action pair. The value function estimate for a state-action pair is an estimate of the return resulting from the agent performing the input action in response to an observation characterizing the given state of the environment 20.

Generally, the reinforcement learning system 100 derives a state representation for a given state from the received observation 106 that characterizes the given state. In some implementations, the state representation for a given state is the observation received by the reinforcement learning system 100 that characterizes the given state. In some other implementations, the value function representation may be a recurrent neural network that maintains an internal state and updates the internal state using each received observation 106. In yet other implementations, the reinforcement learning system 100 may combine the current observation with one or more recent observations to generate the state representation for the current state of the environment 20.

In some implementations, the value function estimate may be associated with a reliability score representative of an accuracy of the value function estimate in estimating the return resulting from the agent performing specific actions in response to a given observation. The reliability score may be determined using a machine learning model, e.g., a deep neural network, that is configured to receive as input a state representation and an action from the set of actions and to output a reliability score that is a measure of the accuracy with which the value function estimate generated in accordance with the value function representation describes the return resulting from the agent performing the input action in response to the received observation 106.

The reinforcement learning system 100 uses the policy management module 120 to select the action 102 to be performed by the agent 10 in response to the observation 106 by determining, for each action in the set of actions, a respective value function estimate in accordance with the value function representation and a respective reliability score. The reinforcement learning system 100 then adjusts the respective value function estimate for the action using the reliability score for the action and uses the adjusted value function estimate to select the action 102 to be performed by the agent 10.

Once the agent 10 has performed the selected action 102, the reinforcement learning system 100 identifies a reward 104 resulting from the agent 10 performing the selected action 102 in the environment 20. The reward 104 is an immediate actual reward resulting from the agent 10 performing the selected action 102 in response to the observation 102. The reinforcement learning system 100 may use the reward 104 to update the value function representation. The reinforcement learning system 100 may also then update the manner through which the reliability score is determined to reflect the change in the measure of accuracy in the value function estimates resulting from the agent 10 having performed the selected action 102 in response to the observation 102.

The reinforcement learning system 100 may also access expert trajectories stored in an expert trajectory database 130 communicably connected to the reinforcement learning system 100. How communication links between the reinforcement learning system 100 and the agent 10, the environment 20 and the expert trajectory database 130 are implemented will depend inter alia on how the reinforcement learning system 100 and the agent 10, the environment 20 and the expert trajectory database 130 are implemented.

Broadly speaking, the reinforcement learning system 100 takes a pre-determined confidence level (e.g. set by a user thereof) and a set of expert trajectories as input and outputs a constraint that is at least as constraining as an unknown expert constraint with the desired pre-determined confidence level. This ensures that any policy that satisfies the outputted constraint will necessarily satisfy the unknown expert constraint with the desired confidence level. In order to illustrate this problematic, the illustrative task of autonomous driving is taken as an example. Human drivers often follow unspecified constraints to ensure safety and comfort. This unspecified constraints may be referred to “unknown expert constraints” for the reinforcement learning system 100. Since it may be difficult and cumbersome to manually specify suitable constraints for safety and comfort, it is common practice to learn such constraints from human demonstrations (i.e. from expert entities). Hence given a set of human demonstrations, such techniques infer constraints that those expert demonstrations satisfy most of the time. In practice, it may be desirable to obtain constraints with a desired level of confidence that they are actually constraints for the expert entities.

Also, the present disclosure provides an approach to determine whether or not an increase of the number of expert trajectories is desirable to obtain a satisfying policy that achieves at least a desired threshold performance.

In the context of the present disclosure, a goal of a constraint is to ensure some notion of safety or that some guarantees are achieved with respect to the agent 10 executing actions in the environment 20. When constraints are learnt by the reinforcement learning system 100, there is some uncertainty about the resulting constraints. The resulting constraints may be more or less constraining than the unknown expert constraint. When the learnt constraint is less constraining than the unknown expert constraint, a policy optimized based thereon may compromise safety and may fail to provide desirable guarantees. It may thus be desirable to allow selection of a confidence level based on which constraints are inferred.

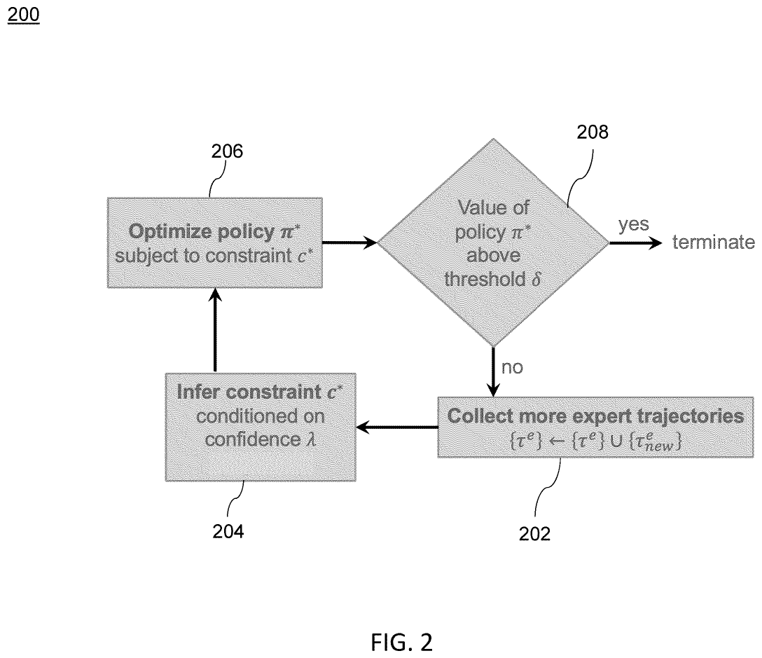

FIG. 2 is a diagram of a pipeline 200 for adjusting a number of expert trajectories used to optimize a policy subjected to an inferred constraint by reinforcement learning system 100, the inferred constraint having been inferred based on a set of expert trajectories.

At block 202, a first set of expert trajectories resolving a given task is collected by the reinforcement learning system 100 from the expert trajectory database 130. At block 204, a constraint c* is inferred from the first set of expert trajectories, the inference being conditioned on a pre-determined confidence level λ such that the inferred constraint c* is at least, with a probability above the pre-determined confidence λ, as constraining as an unknown expert constraint that the expert trajectories of the first set abide by. Inference of the constraint c* is described in greater details herein after.

At block 206, a policy π* for executing the given task is optimized based on the inferred constraint c*. For example and without limitation, the optimization may be made by employing Proximal Policy Optimization (PPO) Lagrange and/or PPO-penalty algorithms.

At block 208, a policy-value of the policy π* is determined and compared with a pre-determined value threshold δ. In response to the policy-value being below the pre-determined value threshold δ, the set of expert trajectories may be flagged as insufficient by the reinforcement learning system 100.

In circumstances where the first set of expert trajectories is flagged as insufficient, the reinforcement learning system 100 causes an updated thereof by adding additional expert trajectories thereto and thus augment the number of expert trajectories. There is thus a higher number of expert trajectories from which the inferred constraint c* may be inferred. The pipeline 200 may be iteratively executed in such manner until the policy-value exceeds the pre-determined value threshold δ. Known policy optimization algorithms may be used to determine said policy-value such as, for example and without limitation, PPO-Lagrange or PPO-penalty algorithms.

Therefore, it can be said that the pipeline 200 allows determining whether a number of expert trajectories is sufficient to reach a policy-value threshold. The developers of the present technology have realized that, when the number of expert trajectories is relatively small, the inferred constraint c* tends to be relatively constraining, yielding a low policy-value. As the number of expert trajectories increases, the inferred constraint for a given confidence level can be relaxed, yielding a relatively high policy-value.

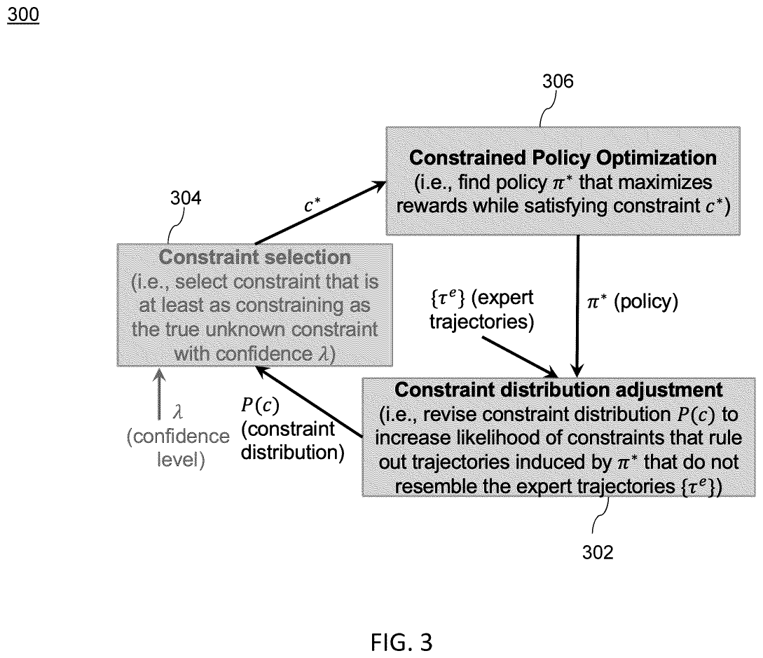

FIG. 3 is a flow diagram representative of steps of a pipeline 300 executed by the reinforcement learning system 100 to infer a constraint that is at least as constraining as an unknown expert constraint with a probability at least as great as a desired confidence level, the set of expert trajectories used and accessed by the reinforcement learning system 100 complying with the unknown expert constraint.

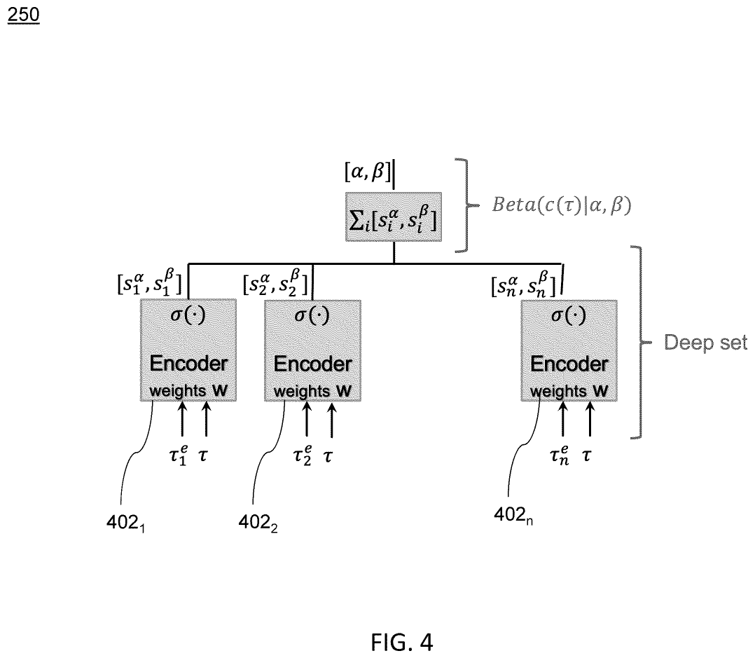

At block 302, a set of expert trajectories {τₑ} is accessed by the reinforcement learning system 100 from the expert trajectory database 130 and a policy π* is accessed. The reinforcement learning system 100 determines a constraint distribution P(c) based on the set of expert trajectories {τₑ} and the policy π*. In some implementations, Bayesian learning may be executed to infer the constraint distribution P(c) over the constraints c. In some other implementations and as will be described in greater details herein after, said inference may be performed by optimizing the neural network 250 (see FIG. 4). The reinforcement learning system 100 further revises the constraint distribution P(c) to increase likelihood of constraints that rule out trajectories induced by the policy π* that do not resemble the expert trajectories of the set of expert trajectories {τₑ}.

In some implementations, the constraint distribution P(c) may be a beta distribution. In the same or other implementations, the constraint distribution adjustment can be performed by Bayesian learning with a suitable projection over a tractable family of distributions such as the family of beta distributions where P(c)=beta(c∥α, β)=P(c|{τₑ}, r, π*).

At block 304, the reinforcement learning system 100 further uses the constraint distribution P(c) to identify a constraint c* that is at least as constraining as a given unknown expert constraint with a confidence equal to or above the pre-determined confidence threshold λ. In some implementations, the constraint function c*(τ) corresponding to confidence λ may be computed by the quantile function quantile_{beta(c(τ)|α,β)}(1−λ)=c*(τ) of the beta distribution (or any other distribution that may be chosen). It can be said that the constraint function c*(τ) is selected with confidence λ.

At block 306, the reinforcement learning system 100 optimizes the policy π* based on the constraint c*. More specifically, the reinforcement learning system 100 updates the policy π* to maximizes rewards while satisfying constraint c*. In some implementations, the constrained policy optimization step can be performed by PPO-Lagrange-based techniques, PPO-penalty-based techniques or any other algorithm or reinforcement learning technique that performs policy optimization subject to constraints. A same algorithm may also be used to estimate the policy-value of the resulting policy π* (see block 208 of FIG. 2).

The resulting constraint function is at least as constraining as the true underlying constraint function with confidence at least A, which provides a desirable guarantee. Moreover, the number of expert trajectories may be increased until a policy is obtained with a desirable value subject to a constraint that is at least as constraining as the true constraint with high confidence.

With respect to the illustrative example of autonomous driving, an expert trajectory τ=(s₀, a₀, s₁, a₁, . . . , sₙ, aₙ) may be a human driver trajectory where sₜ is the state at time step t, which includes the position and velocity of the ego car and surrounding cars. Similarly, at is the action at time step t, which includes the acceleration and steering of the ego car.

A fraction of people who would judge the trajectory τ as safe is noted c(τ)∈[0,1]. More specifically, c(τ)=Πₜϕ(sₜ, aₜ) may be decomposed into a product of feasibility factors ϕ(sₜ, aₜ) indicating the fraction of people who would judge the state-action pair at time t as safe. In some other example, c(τ) may not be decomposable into a product. More generally, c(τ) can be any function that returns the probability that someone would judge τ as safe.

A distribution over the fraction of people who would judge τ as safe is noted P(c(τ))=beta(c(τ) |α,β). In this illustrative example, this distribution is a beta distribution with parameters α and β. P(c(τ)) represents the epistemic uncertainty of the learning algorithm, where epistemic uncertainty refers to the uncertainty that is due to a limited amount of data (e.g., limited number of expert trajectories).

The desired pre-determined confidence level is noted λ (e.g., λ=90%) and c*(τ) is the highest fraction of people such that the true fraction of people c(τ) is at least as great as c*(τ) with confidence λ (i.e., P(c(τ)≥c*(τ))≥λ). The reinforcement learning system 100 will return c*(τ) since this is the constraint function that corresponds to the confidence level λ.

In some implementations, the reinforcement learning system 100 employs encoders to optimize a policy based on expert trajectories according to a pre-determined confidence level. FIG. 4 is a block diagram of an architecture of encoders 402₁ to 402ₙ of a neural network 250 employed by the reinforcement learning system 100 to optimize a policy based on expert trajectories according to a pre-determined confidence level. More specifically, the neural network 250 may infer the distribution P(c(τ))=beta(c(τ)|α, β).

More specifically, the neural network formed of the encoders 402₁ to 402ₙ hyperparameter α and β of the beta distribution over c(τ). In this implementation, each encoder 402; block shares the same set of weights w. In use, each encoder 402; receives an expert trajectory τᵢ^{e} as an input along with a trajectory τ to be assessed in the optimization of the policy π*. These encoders 402ᵢ may be bidirectional attention flows, transformers or any other type of encoder that returns two numbers sᵢ^{α}, sᵢ^{β}∈[0,1] that are contribution of expert trajectory the towards α and β in evaluating the safety of trajectory τ.

It should be noted that the probability that an expert would generate a trajectory τ is given by: P(τ|c*, r)∝exp(r(τ))c*(τ) where r(τ) is the amount of reward accumulated in τ and c*(τ) is the constraint to be inferred. Hence, by optimizing the weights w of the encoders 402ᵢ to maximize P(τ|c*, r), the reinforcement learning system 100 may determine the weights w that define a distribution over constraints c(τ) that ensures that the expert trajectories will be generated with a relatively high probability.

In this implementation, the pipeline 200 may be adjusted such that, at block 204, the reinforcement learning system 100 infers the constraint c* by solving the following problem:

$${max}_{w} {\sum }_{τ ∈ expert} log P ( τ \vert {c}^{*} , r )$$

$$where$$

$${c}^{*} ( τ ) = {quantile}_{beta ( c ( τ ) \vert {α}_{w} , {β}_{w} )} ( 1 - λ ) .$$

In addition, at block 206, the reinforcement learning system 100 estimates the policy-value of the optimized policy π* as: V(s₀)=E_{P(τ|c*,r)}[r(τ)] where r(τ) is a trajectory reward, or “cumulative” reward.

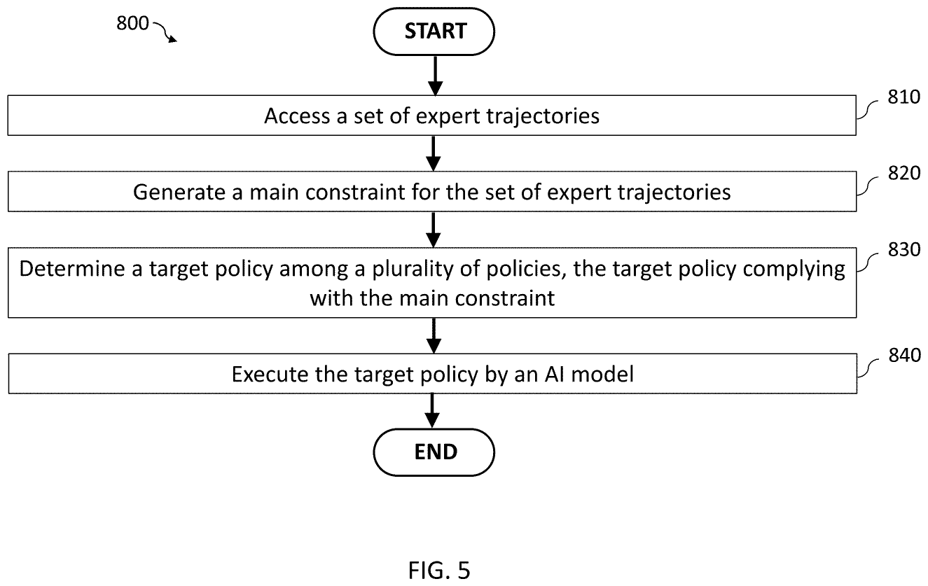

FIG. 5 a flow diagram of a method 800 for executing confidence-aware reinforcement learning for an Artificial Intelligence (AI) model for subsequent deployment of that AI model in an environment according to some implementations of the present technology. In one or more aspects, the method 800 or one or more steps thereof may be performed by a processor or a computer system, such as the reinforcement learning system 100. The method 800 or one or more steps thereof may be embodied in computer-executable instructions that are stored in a computer-readable medium, such as a non-transitory mass storage device, loaded into memory and executed by a CPU. Some steps or portions of steps in the flow diagram may be omitted or changed in order.

The method 800 starts with accessing, at operation 810, a set of expert trajectories. Each expert trajectory includes a sequence of expert state-action pairs, a given one of the expert trajectories including information about a given state of the environment and a corresponding action that is to be executed in response to the given state, the expert entities complying with an expert constraint that is unknown.

The method 800 continues with generating, at operation 820, a main constraint for the set of expert trajectories. The main constraint is conditioned on a pre-determined confidence level, the pre-determined confidence level being indicative of a probability that the main constraint is at least as constraining as the expert constraint. In this implementation, the main constraint includes one or more rules limiting the actions that are executable by the AI model.

In some non-limiting implementations, generating a main constraint for the set of expert trajectories includes determining a constraint distribution based on the set of expert trajectories, and selecting a constraint from the constraint distribution based on the pre-determined confidence level as the main constraint. For example and without limitations, Bayesian learning or the neural network described in FIG. 4 may be used to determine the constraint distribution. In some implementations, the constraint distribution is a beta distribution. In some non-limiting implementations, selecting the constraint from the constraint distribution includes selecting the lower boundary constraint of a quantile of the constraint distribution based on the pre-determined confidence level.

For example, the main constraint may be selected as:

quantile_{P(c)}(1−λ)

where P(c) is the constraint distribution and λ is the pre-determined confidence level.

In some non-limiting implementations, determining a constraint distribution includes employing a neural network encoding the set of expert trajectories to determine, for each of the expert trajectory, a set of contribution factors and adjusting a template distribution according to the set of contribution factors to form the constraint distribution.

In some non-limiting implementations, each expert trajectory is encoded with a corresponding encoder having corresponding weights in the neural network.

The method 800 continues with determining, at operation 830, a target policy among a plurality of policies, the target policy complying with the main constraint.

In some non-limiting implementations, the method 800 further includes accessing a set of policies, each policy being a mapping from states to actions for the sequences of expert state-action pairs of the expert trajectories, an execution of the policy aiming at maximizing a reward. In these implementations, the method 800 may also include determining a policy complying with the main constraint and executing the policy by iteratively executing the actions of the policy, receiving indication of rewards from and states of the environment, and adjusting the policy based on outcomes of the actions and received rewards. For example, a given policy that satisfies a constraint may be adjusted and optimized using PPO-Lagrange-based techniques, PPO-penalty-based techniques or any other suitable algorithm.

In the same or other implementations, the method 800 further includes, prior to executing the policy, determining a policy-value of the target policy, and in response to the policy-value being below a pre-determined value threshold, flagging the set of expert trajectories as insufficient. The method may further include augmenting the set of expert trajectories with additional expert trajectories until the policy-value exceeds the pre-determined value threshold.

In the same or other implementations, determining the policy-value of the policy includes determining an expected cumulative reward based on rewards associated with the mapping of action-state pairs of the policy.

The method 800 continues with executing, at operation 840, the target policy by the AI model.

While the above-described implementations have been described and shown with reference to particular steps performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

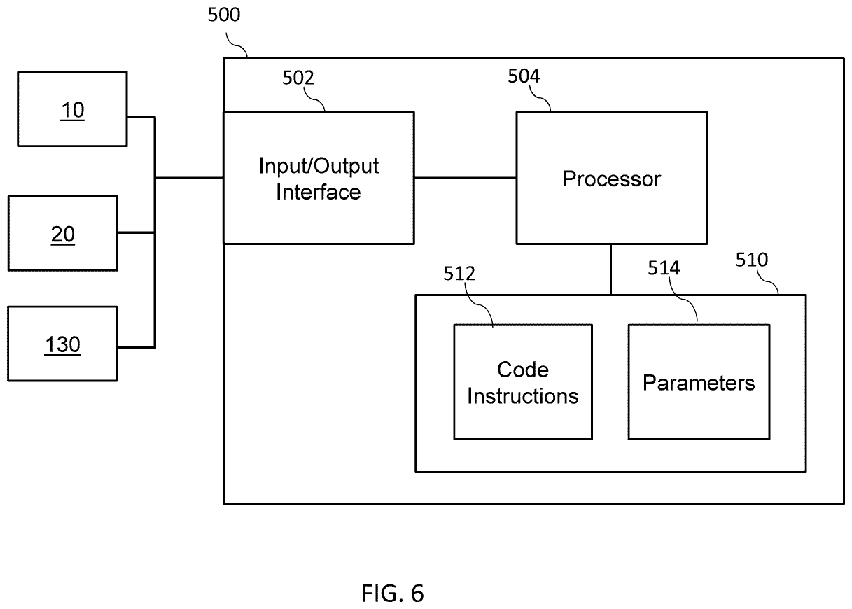

As an example, FIG. 6 is a schematic block diagram of a controller 500 for executing the method 800 according to an implementation of the present technology. The reinforcement learning system 100 may be implemented as the controller 500. The controller 500 comprises a processor or a plurality of cooperating processors (represented as a processor 504 for simplicity), a memory device or a plurality of memory devices (represented as a memory device 510 for simplicity), and a input/output interface 502 allowing the controller 500 to communicate with other components of the reinforcement learning system 100 and/or other components in remote communication with the reinforcement learning system 100 such as the expert trajectory database 130. The processor 504 is operatively connected to the memory device 510 and to the input/output interface 502. The memory device 510 includes a storage for storing parameters 514, including for example and without limitation the above-mentioned confidence levels. The memory device 510 may also comprise a non-transitory computer-readable medium for storing code instructions 512 that are executable by the processor 504 to allow the controller 500 to perform the various tasks allocated to the controller 500 in the methods disclosed herein.

The controller 500 is operatively connected, via the input/output interface 502, to the agent 10, the environment 20 and the expert trajectory database 30. The controller 500 executes the code instructions 512 stored in the memory device 510 to implement the various above-described functions that may be present in a particular implementation. FIG. 6 as illustrated represents a non-limiting implementation in which the controller 500 orchestrates operations of the labelling module 100. This particular implementation is not meant to limit the present disclosure and is provided for illustration purposes.

It should be expressly understood that not all technical effects mentioned herein need to be enjoyed in each and every implementation of the present technology. Modifications and improvements to the above-described implementations of the present technology may become apparent to those skilled in the art. The foregoing description is intended to be exemplary rather than limiting. The scope of the present technology is therefore intended to be limited solely by the scope of the appended claims.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for executing confidence-aware reinforcement learning for an Artificial Intelligence (AI) model for subsequent deployment of that AI model in an environment, the method comprising:
accessing a set of expert trajectories, each expert trajectory comprising a sequence of expert state-action pairs, a given one of the expert trajectories including information about a given state of the environment and a corresponding action that is to be executed in response to the given state, the expert entities complying with an expert constraint that is unknown;
generating a main constraint for the set of expert trajectories, the main constraint being conditioned on a pre-determined confidence level, the pre-determined confidence level being indicative of a probability that the main constraint is at least as constraining as the expert constraint, the main constraint comprising one or more rules limiting the actions that are executable by the AI model;
determining a target policy among a plurality of policies, the target policy complying with the main constraint; and
executing the target policy by the AI model.

2. The method of claim 1, further comprising:
accessing a set of policies, each policy being a mapping from states to actions for the sequences of expert state-action pairs of the expert trajectories, an execution of the policy aiming at maximizing a reward;
determining a policy complying with the main constraint;
executing the policy by iteratively:
executing the actions of the policy,
receiving indication of rewards from and states of the environment, and
adjusting the policy based on outcomes of the actions and received rewards.

3. The method of claim 2, further comprising, prior to executing the policy:
determining a policy-value of the target policy;
in response to the policy-value being below a pre-determined value threshold, flagging the set of expert trajectories as insufficient.

4. The method of claim 3, further comprising augmenting the set of expert trajectories with additional expert trajectories until the policy-value exceeds the pre-determined value threshold.

5. The method of claim 3, wherein determining the policy-value of the policy comprises determining an expected cumulative reward based on rewards associated with the action-state pairs of the policy.

6. The method of claim 1, wherein generating a main constraint for the set of expert trajectories comprises:
determining a constraint distribution based on the set of expert trajectories;
selecting a constraint from the constraint distribution based on the pre-determined confidence level as the main constraint.

7. The method of claim 6, wherein selecting the constraint from the constraint distribution comprises selecting the lower boundary constraint of a quantile of the constraint distribution based on the pre-determined confidence level.

8. The method of claim 7, wherein the main constraint is:
quantile_{P(c)}(1−λ)
where P(c) is the constraint distribution and λ is the pre-determined confidence level.

9. The method of claim 6, wherein determining a constraint distribution comprises:
employing a neural network encoding the set of expert trajectories to determine, for each of the expert trajectory, a set of contribution factors; and
adjusting a template distribution according to the set of contribution factors to form the constraint distribution.

10. The method of claim 9, wherein each expert trajectory is encoded with a corresponding encoder having corresponding weights in the neural network.

11. A system for executing confidence-aware reinforcement learning for an Artificial Intelligence (AI) model for subsequent deployment of that AI model in an environment, the system comprising a controller and a memory storing a plurality of executable instructions which, when executed by the controller, cause the system to:
access a set of expert trajectories, each expert trajectory comprising a sequence of expert state-action pairs, a given one of the expert trajectories including information about a given state of the environment and a corresponding action that is to be executed in response to the given state, the expert entities complying with an expert constraint that is unknown;
generate a main constraint for the set of expert trajectories, the main constraint being conditioned on a pre-determined confidence level, the pre-determined confidence level being indicative of a probability that the main constraint is at least as constraining as the expert constraint, the main constraint comprising one or more rules limiting the actions that are executable by the AI model;
determine a target policy among a plurality of policies, the target policy complying with the main constraint; and
execute the target policy by the AI model.

12. The system of claim 11, wherein the system is further configured to:
access a set of policies, each policy being a mapping from states to actions for the sequences of expert state-action pairs of the expert trajectories, an execution of the policy aiming at maximizing a reward;
determine a policy complying with the main constraint;
execute the policy by iteratively:
executing the actions of the policy,
receiving indication of rewards from and states of the environment, and
adjusting the policy based on outcomes of the actions and received rewards.

13. The system of claim 12, wherein the system is further configured to, prior to executing the policy:
determine a policy-value of the target policy;
in response to the policy-value being below a pre-determined value threshold, flag the set of expert trajectories as insufficient.

14. The system of claim 13, wherein the system is further configured to augment the set of expert trajectories with additional expert trajectories until the policy-value exceeds the pre-determined value threshold.

15. The system of claim 13, wherein the system is further configured to, upon determining the policy-value of the policy, determine an expected cumulative reward based on rewards associated with the action-state pairs of the policy.

16. The system of claim 11, wherein the system is further configured to, upon generating a main constraint for the set of expert trajectories:
determine a constraint distribution based on the set of expert trajectories;
select a constraint from the constraint distribution based on the pre-determined confidence level as the main constraint.

17. The system of claim 16, wherein the system is further configured to select the constraint from the constraint distribution by selecting the lower boundary constraint of a quantile of the constraint distribution based on the pre-determined confidence level.

18. The system of claim 17, wherein the main constraint is:
quantile_{P(c)}(1−λ)
where P(c) is the constraint distribution and λ is the pre-determined confidence level.

19. The system of claim 16, wherein the system is further configured to, upon determining a constraint distribution:
employ a neural network encoding the set of expert trajectories to determine, for each of the expert trajectory, a set of contribution factors; and
adjust a template distribution according to the set of contribution factors to form the constraint distribution.

20. The system of claim 19, wherein each expert trajectory is encoded with a corresponding encoder having corresponding weights in the neural network.
